(19) United States
(12) Patent Application Publication
(10) Pub. No.: US 2007/0030569 A1
(43) Pub. Date: Feb. 8, 2007

(54) Broad band antireflection coating and method of making same

(75) Inventors: Yiwei Lu, Ann Arbor, MI (US); Tamzen L. Van Skike, Carleton, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/196,476

(22) Filed: Aug. 4, 2005

(51) Int. Cl. G02B 1/10

(52) U.S. Cl. 359/586; 359/580

(57) ABSTRACT

A coated article includes a broad band antireflection (AR) coating that utilizes aluminum oxynitride (AlOₓN_{y}) in the medium index (index of refraction “n”) layer of the coating. In certain example embodiments, the coating may include the following layers from the glass substrate outwardly: aluminum oxynitride (AlOₓN_{y}) medium index layer/high index layer/low index layer. In certain example embodiments, depending on the chemical and optical properties of the low and high index layers and the substrate, x and y of the aluminum oxynitride (AlOₓN_{y}) of the medium index layer can be selected to optimize the overall performance of the broad band antireflection coating.

This invention relates to a coated article including an anti-reflective coating, and/or a method of making the same. In certain example embodiments, a broad band antireflection (AR) coating utilized aluminum oxynitride (AlOₓN_{y}) as the medium index layer of the coating. In certain example embodiments, the coating may include the following layers from the glass substrate outwardly: aluminum oxynitride (AlOₓN_{y}) medium index layer/high index layer/low index layer. In certain example embodiments, depending on the chemical and optical properties of the low and high index layers and the substrate, x and y of the aluminum oxynitride (AlOₓN_{y}) of the medium index layer can be selected to optimize the overall performance of a broad band antireflection coating.

### BACKGROUND AND SUMMARY OF EXAMPLE EMBODIMENTS OF THE INVENTION

Anti-reflective coatings are known in the art. However, the anti-reflective efficiency of such coatings is open to improvement. Thus, it will be appreciated that there exists a need in the art for improved anti-reflection (AR) coatings for coated articles such as windows and the like.

In certain example embodiments of this invention, a broad band dielectric AR coating includes at least three dielectric layers, namely a high index layer, a medium index layer and a low index layer. The meanings of “high”, “medium” and “low” are simply that the medium index layer has an index of refraction (n) less than that of the high index layer and greater than that of the low index layer (no specific values are required merely by the use of “high”, “medium” and “low”). The high, medium and low index layers are typically dielectric layers in certain example embodiments of this invention, in that they are not electrically conductive.

In certain example embodiments of this invention, the medium index layer is a bottom layer of the AR coating and is of or includes aluminum oxynitride (AlOₓN_{y}). In certain example embodiments, the aluminum oxynitride has an index of refraction of from about 1.63 to 2.05, more preferably from about 1.65 to 2.0, even more preferably from about 1.7 to 1.95, and most preferably from about 1.72 to 1.93 (at 550 nm). In certain example embodiments, the high index layer is provided between the low index layer and the medium index layer comprising aluminum oxynitride, so that in certain example instances the low index layer may be an uppermost layer of the coating.

By controlling the oxygen to nitrogen ratio (O/N ratio), AlOₓN_{y} having different adhesion (to the high index layer and the substrate), stress and optical properties such as index of refraction can be achieved. Depending on chemical and optical properties of the low index layer, the high index layer and the substrate, AlOₓN_{y} having the optimized characteristics can be selected to optimize the overall performance of a broad band AR coating. In certain example embodiments of this invention, the high index layer has an index of refraction of at least about 2.0 (more preferably from about 2.0 to 2.6, even more preferably from about 2.1 to 2.6, and sometimes from about 2.2 to 2.5), and the low index layer has an index of refraction of from about 1.35 to 1.75, more preferably from about 1.4 to 1.75 (even more preferably from about 1.4 to 1.65, even more preferably from about 1.4 to 1.6, and sometimes from about 1.4 to 1.55).

In certain example embodiments of this invention, there is provided a coated article including an anti-reflection coating supported by a glass substrate, the coated article comprising: the glass substrate supporting the anti-reflection coating, wherein the anti-reflection coating comprises a low index layer having a low index of refraction (n), a medium index layer having a medium index of refraction, and a high index layer having a high index of refraction; wherein the medium index layer comprises aluminum oxynitride and is on and in direct contact with the glass substrate, and wherein the medium index layer comprising aluminum oxynitride has an index of refraction of from about 1.63 to 2.05, more preferably from about 1.65 to 2.0; wherein the medium index layer comprising aluminum oxynitride has an index of refraction less than that of the high index layer and greater than that of the low index layer; and wherein the high index layer has an index of refraction of at least about 2.0, the low index layer has an index of refraction of from about 1.35 to 1.75; and wherein the high index layer is located between and contacting the medium index layer and the low index layer.

In other example embodiments of this invention, there is provided a coated article including an anti-reflection coating supported by a substrate, the coated article comprising: the substrate supporting the anti-reflection coating, wherein the anti-reflection coating comprises a low index layer having a low index of refraction (n), a medium index layer having a medium index of refraction, and a high index layer having a high index of refraction; wherein the medium index layer comprises aluminum oxynitride and is located below each of the high index layer and the low index layer in the coating; wherein the medium index layer comprising aluminum oxynitride has an index of refraction less than that of the high index layer and greater than that of the low index layer.

In certain example embodiments, each of the high, low and medium index layers are dielectric layers. In certain example embodiments, the coating includes no metallic or electrically conductive layer, and/or has no layer deposited via pyrolysis.

### BRIEF DESCRIPTION OF THE DRAWINGS

FIG. 1 is a cross sectional view of a coated article according to an example embodiment of this invention.

FIG. 2 is a cross sectional view of a coated article according to an example embodiment of this invention, with antireflective coatings being provided on both major surfaces of the substrate.

FIG. 3 is a graph illustrating reflection spectra of a piece of glass having anti-reflective coatings on both major surfaces thereof according to an example of this invention.

FIGS. 4(a) and 4(b) graphically illustrate photopic reflections and element ratio data from coated articles according to different example embodiments of this invention.

FIG. 5 is a graph illustrating reflectivity percentages at different wavelengths of example coated articles according to different example embodiments of this invention.

FIG. 6 is a graph illustrating reflection spectra of examples of this invention.

### DETAILED DESCRIPTION OF EXAMPLE EMBODIMENTS OF THE INVENTION

Referring now more particularly to the accompanying drawings in which like reference numerals indicate like parts throughout the several views.

Certain example embodiments of this invention relate to a coated article including an anti-reflective coating, and/or a method of making the same. In certain example embodiments, a broad band antireflection (AR) coating utilized aluminum oxynitride (AlOₓN_{y}) as the medium index layer of the coating. In certain example embodiments, the coating may include the following layers from the glass substrate outwardly: aluminum oxynitride (AlOₓN_{y}) medium index layer/high index layer/low index layer. In certain example embodiments, depending on the chemical and optical properties of the low and high index layers and the substrate, x and y of the aluminum oxynitride (AlOₓN_{y}) of the medium index layer can be selected to optimize the overall performance of a broad band antireflection coating. Coated articles according to certain example embodiments of this invention may be used in the context of architectural windows, vehicle windows, fireplace door windows, oven door windows, ophthalmic lens applications, and/or the like.

In certain example embodiments of this invention, a broad band dielectric AR coating includes at least three dielectric layers, namely a high index layer, a medium index layer and a low index layer. The meanings of “high”, “medium” and “low” are simply that the medium index layer has an index of refraction (n) less than that of the high index layer and greater than that of the low index layer (no specific values are required merely by the use of “high”, “medium” and “low”). The high, medium and low index layers are typically dielectric layers in certain example embodiments of this invention, in that they are not electrically conductive.

In certain example embodiments of this invention, the medium index layer is a bottom layer of the AR coating and is of or includes aluminum oxynitride (AlOₓN_{y}). In certain example embodiments, the aluminum oxynitride has an index of refraction of from about 1.63 to 2.05, more preferably from about 1.65 to 2.0, even more preferably from about 1.7 to 1.95, and most preferably from about 1.72 to 1.93 (at 550 nm). In certain example embodiments, the high index layer is provided between the low index layer and the medium index layer comprising aluminum oxynitride, so that in certain example instances the low index layer may be an uppermost layer of the coating.

By controlling the oxygen to nitrogen ratio (O/N ratio), AlOₓN_{y} having different adhesion (to the high index layer and the substrate), stress and optical properties such as index of refraction can be achieved. Depending on chemical and optical properties of the low index layer, the high index layer and the substrate, AlOₓN_{y} having the optimized characteristics can be selected to optimize the overall performance of a broad band AR coating. In certain example embodiments of this invention, the high index layer has an index of refraction of at least about 2.0 (more preferably from about 2.0 to 2.6, even more preferably from about 2.1 to 2.6, and sometimes from about 2.2 to 2.5), and the low index layer has an index of refraction of from about 1.35 to 1.75 (more preferably from about 1.4 to 1.65, even more preferably from about 1.4 to 1.6, and sometimes from about 1.4 to 1.55).

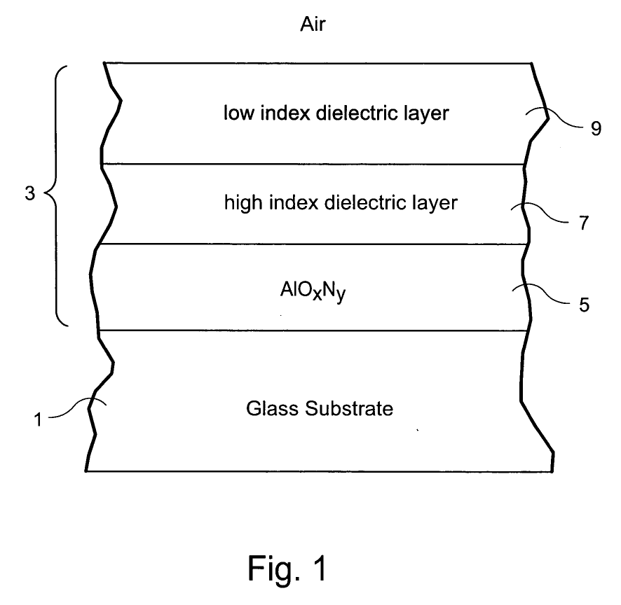

FIG. 1 is a cross sectional view of an example coated article according to an example embodiment of this invention. The coated article of the FIG. 1 embodiment includes substrate 1 that supports antireflective (AR) coating 3. Substrate 1 is typically a glass substrate, but may be other materials in certain example instances such as polycarbonate or acrylic. The AR coating 3 includes medium index layer 5 of or including aluminum oxynitride, high index layer 7, and low index layer 9. In this example embodiment, the low index layer 9 is the outermost layer of the coating 3, whereas the medium index layer 5 is the bottom-most layer of the AR coating 3. The AR coating 3 is a dielectric type coating in that each of layers 5, 7 and 9 is a dielectric layer (i.e., not electrically conductive). Thus, the AR coating 3 of the FIG. 1 embodiment has no IR reflecting layer (i.e., no metallic layer of Ag, Au or the like), and no transparent conductive oxide (TCO) layer such as a pyrolytically deposited metal oxide/nitride.

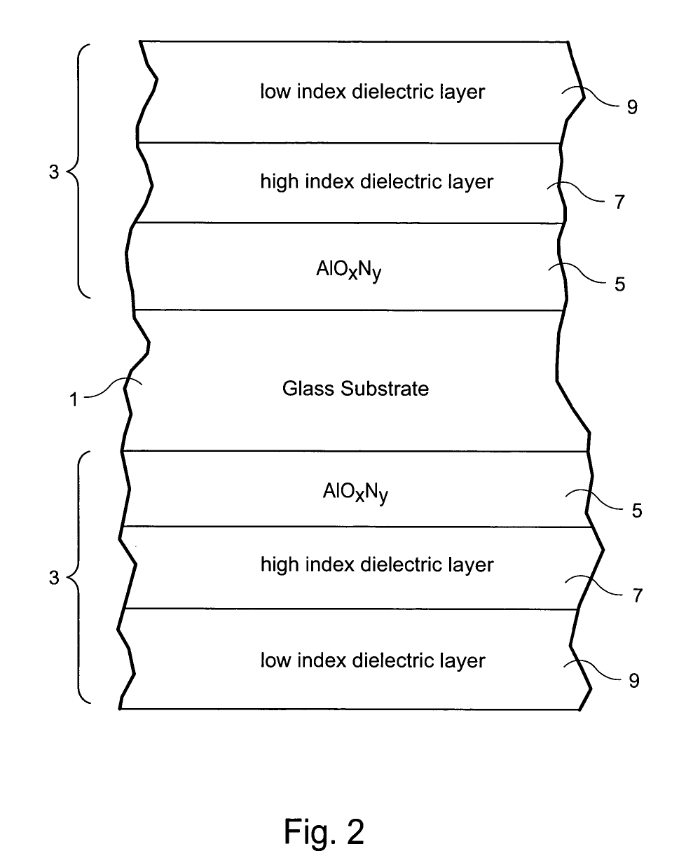

The AR coating 3 of FIG. 1 may be provided on only one major surface of glass substrate 1 as shown in FIG. 1. However, FIG. 2 illustrates an alternative example embodiment of this invention where the coating 3 is provided on both the major surfaces of the glass substrate 1. In other words, a first AR coating 3 is provided on a first major surface of the substrate 1 and a second AR coating 3 is provided on a second major surface of the substrate 1.

The refractive index (n) of medium index layer 5 is less than the refractive index of the high index layer 7 and greater than the refractive index of the low index layer 9. In certain example embodiments, the low index layer 9 may be of or include silicon oxide (e.g., SiO₂), MgF, or their alloyed oxide and fluoride. In certain example embodiments, the high index layer 7 may be of or include a metal oxide, metal nitride and/or metal oxynitride such as titanium oxide (e.g., TiO₂), zinc oxide, silicon nitride, or the like.

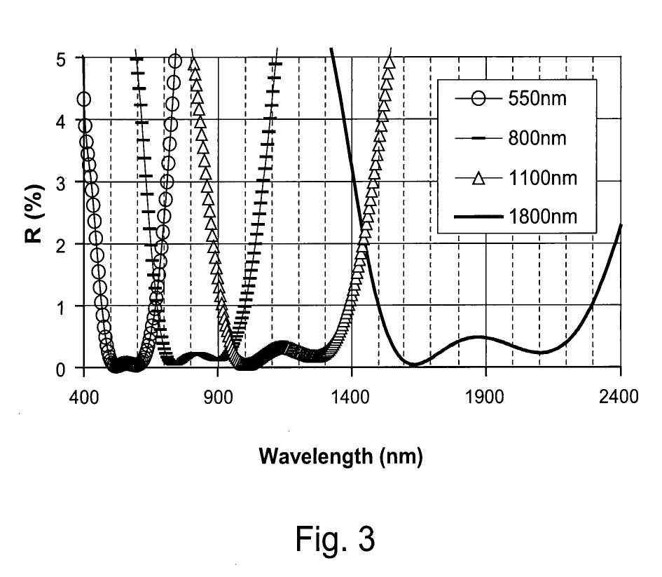

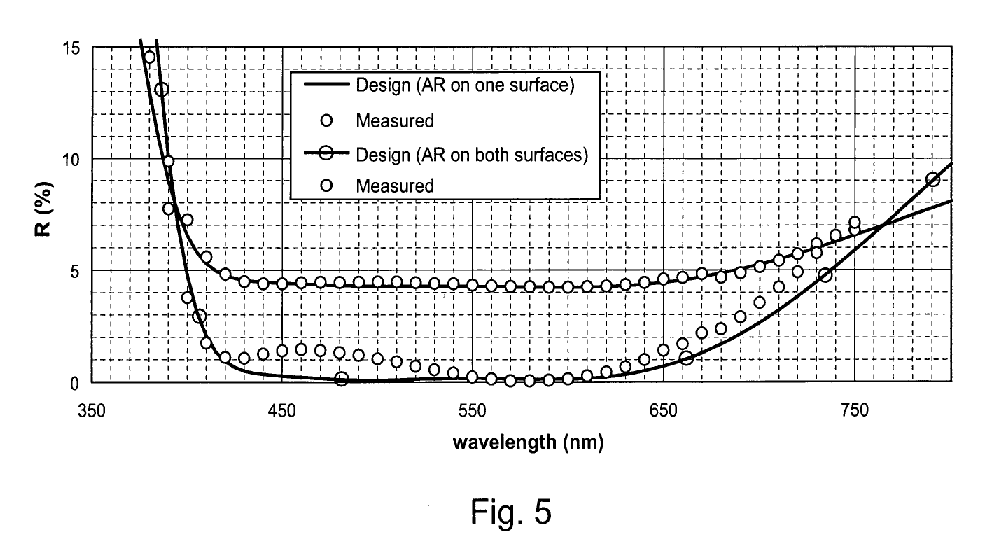

In certain example embodiments, medium index layer 5 of or including aluminum oxynitride is from about 10-120 nm thick, more preferably from about 30-100 nm thick, and most preferably from about 45-80 nm thick. In certain example embodiments, the high index layer 7 is from about 40-200 nm thick, more preferably from about 50-150 nm thick, and most preferably from about 80-120 nm thick. In certain example embodiments, the low index layer 9 is from about 20-200 nm thick, more preferably from about 50-150 nm thick, and most preferably from about 65-110 nm thick. In certain example embodiments, the low index layer 9 is thicker than the medium index layer 5 but thinner than the high index layer 7. In certain example embodiments such as a broadband AR in visible (e.g., the AR or antireflective design shown in FIG. 5 has AlOxNy index=1.78, and 66 nm AlOxNy, 96 nm TiO2, and 84 nm SiO2), by multiplying every layer thickness by a factor 2 or the like, we may move the AR center wavelength from 550 nm in visible to 1100 nm in near IR as shown in FIG. 3. Also, by changing the thickness ratio among AlOxNy, TiO2, and SiO2, one can have certain control on the bandwidth of the broad band AR.

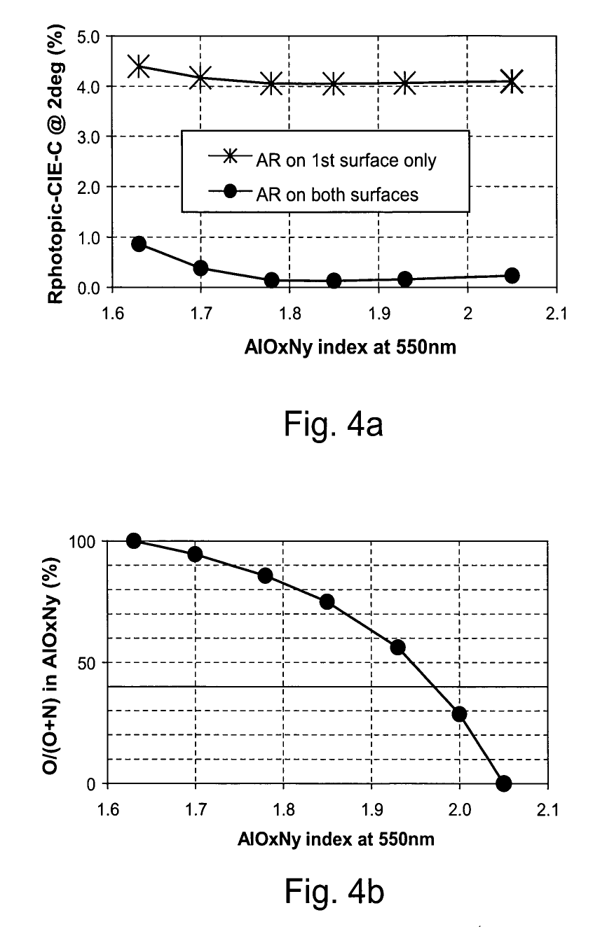

The desired optical performance and other physical properties, such as stress, adhesion, chemical and mechanical durability, and the like of the medium index layer can be achieved by adjusting the oxygen to nitrogen ratio (O/N ratio), and thus x and y, of the AlOₓN_{y} inclusive medium index layer 5 as shown in FIGS. 4(a) and 4(b). In this respect, FIG. 4(a) illustrates performance of visible AR coating 3 designs having different AlOxNy indices (n) varying from 1.63 (Al₂O₃) to 2.05 (AlN) at 550 nm; whereas FIG. 4(b) illustrates how the refractive index (n) of the layer 5 can be varied by adjusting the O/N ratio. In certain example embodiments of this invention, the O/(O+N) ratio (atomic) in the AlOxNy of medium index layer 5 is from about 0.29 to 0.99, more preferably from about 0.50 to 0.95, and most preferably from about 0.56 to 0.93 (even from about 0.64 (e.g., index=1.90) to 0.85 (e.g., index=1.78) in certain example instances). It has been found that this range of O/(O+N) results in the best AR and durability characteristics. In particular, FIG. 4(a) illustrate photopic reflections from a piece of glass 1 simulate to have the coating of the below example thereon, on one or both sides of the glass as indicated in the figure. The estimated O/(O+N) ratio vs. index (n) of the aluminum oxynitride is shown in FIG. 4(b).

In certain example embodiments, the AR coating may be designed to reduce undesired reflection. In most cases, reduced reflection comes with increased transmission such as AR on picture frame glass that a higher than 98% transmission is desired. However, the increased transmission may not always be desired. For example, the AR coating in the area overlapped with black matrix in a display requires reflectivity as low as possible, but does not care about transmission (T). In other words, the transmission depends on substrates and applications.

Coated articles with antireflection coatings 3 are useful in certain window applications as mentioned herein. In this respect, coated articles according to certain example embodiments of this invention have a visible transmission of at least about 50%, more preferably of at least about 60%, and most preferably of at least about 70%.

### EXAMPLES

An example AR coating 3 was made as follows: AlOₓN_{y} layer 5 (medium index layer) about 66 nm thick, TiO₂ layer 7 (example high index layer) about 96 nm thick, and SiO₂ layer 9 (example low index layer) about 84 nm thick. The clear glass substrate was about 5 mm thick, and was soda lime silica type glass. Each of layers 5, 7 and 9 was deposited on the glass substrate 1 by sputtering a target(s). The coating 3 was provided on only one major surface of the glass substrate in certain instances as shown in FIG. 1, but was provided on both major surfaces of the glass substrate in other instance as shown in FIG. 2.

FIG. 3 graphically illustrates reflection spectra of a piece of glass 1 having the three-layered coating described above for the example provided on both major surfaces of the glass as shown in FIG. 2. The parameters x and y of the AlOₓN_{y} layer were adjusted to achieve a refractive index (n) for the medium index layer 5 of about 1.85 (at 550 nm). The design wavelength varied from 550 to 1800 nm to cover different spectra ranges for different applications as shown in FIG. 3. In certain example embodiments of this invention, AR coating 3 has a bandwidth (reflection less than 0.5%)˜40% (e.g., from about 30-50%) of a design wavelength as shown in FIG. 3 so as to be suitable for visible or solar photovoltaic applications. The desired optical performance, stress, and adhesion of the medium index layer can be achieved by adjusting the oxygen to nitrogen ratio (O/N ratio), and thus x and y, of the AlOₓN_{y} inclusive medium index layer 5 as shown in FIGS. 4(a) and 4(b).

FIG. 5 illustrates the reflection spectra of an example having AlOxNy adjusted to achieve a refractive index for the medium index layer 5 of about 1.78 (at 550 nm), on one and both major surfaces of the glass substrate as indicated in the figure. It can be seen that excellent AR characteristics (i.e., low R %) are achieved in wavelength range of from about 450 to 650 nm, and also from about 500 to 600 nm. The design minimizes or reduces photopic reflection (CIE-C, 2°), and the measured value was about 0.4%. Without the AR coatings 3, the 5 mm thick glass 1 had a 7.9% photopic reflection. In certain example embodiments of this invention, the coated article has a photopic reflection of less than about 3.0%, more preferably less than about 1.0%, more preferably less than about 0.5%, and most preferably less than about 0.45%. Following thermal tempering, windex/alcohol wiping and 500 brush strokes, no detectable degradation was observed on the Example. Thus, it has also been found that the use of the aluminum oxynitride results in a surprisingly durable coated article which also has good AR characteristics.

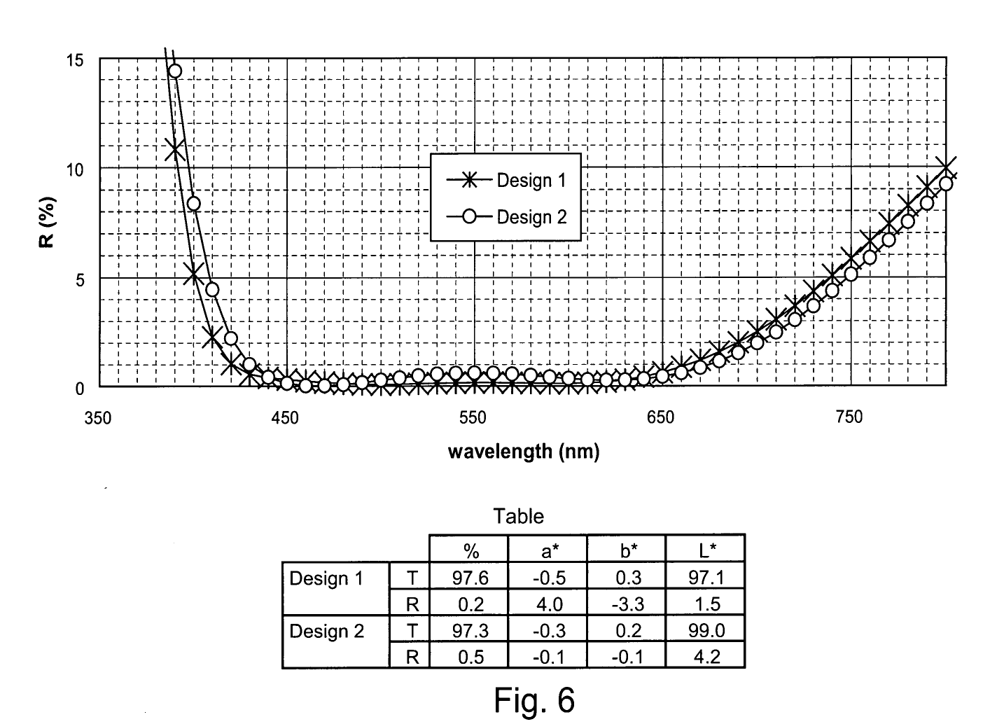

FIG. 6 illustrates the reflection spectra of examples having AlOxNy adjusted to achieve a refractive index for the medium index layer 5 of about 1.78 (at 550 nm), on one and both major surfaces of the glass substrate as indicated in the figure. The design 2 is further optimized to achieve neutral colors on both reflection and transmission that desired in certain applications such as picture frame glass and display windows. It can be seen that excellent AR characteristics (i.e., low R %) are achieved in wavelength range of from about 450 to 650 nm, and also from about 500 to 600 nm. The design minimizes or reduces photopic reflection (CIE-C, 2°), and have both transmission and reflection color coordinates a* and b* within ±=b 1.0.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A coated article including an anti-reflection coating supported by a substrate, the coated article comprising:
the substrate supporting the anti-reflection coating, wherein the anti-reflection coating comprises a low index layer having a low index of refraction (n), a medium index layer having a medium index of refraction, and a high index layer having a high index of refraction;
wherein the medium index layer comprises aluminum oxynitride and is on and in direct contact with the substrate, and wherein the medium index layer comprising aluminum oxynitride has an index of refraction of from about 1.65 to 2.0;
wherein the medium index layer comprising aluminum oxynitride has an index of refraction less than that of the high index layer and greater than that of the low index layer; and
wherein the high index layer has an index of refraction of at least about 2.0, the low index layer has an index of refraction of from about 1.35 to 1.75; and wherein the high index layer is located between and contacting the medium index layer and the low index layer.

2. The coated article of claim 1, wherein the substrate is a glass substrate, and wherein the low index layer is an outermost layer of the anti-reflective coating and is exposed to surrounding atmosphere.

3. The coated article of claim 1, wherein each of the high, medium and low index layers are dielectric layers.

4. The coated article of claim 1, wherein the high index layer has an index of refraction of from about 2.1 to 2.6.

5. The coated article of claim 1, wherein the low index layer has an index of refraction of from about 1.4 to 1.65.

6. The coated article of claim 1, wherein the high index layer comprises an oxide of titanium

7. The coated article of claim 1, wherein the low index layer comprises SiO₂.

8. The coated article of claim 1, wherein the medium index layer comprising aluminum oxynitride has an index of refraction of from about 1.72 to 1.93.

9. The coated article of claim 1, wherein the antireflection coating consists essentially of the high index layer, the low index layer and the medium index layer.

10. The coated article of claim 1, wherein the aluminum oxynitride has an oxygen to nitrogen ratio characterized by O/(O+N) of from about 0.29 to 0.99.

11. The coated article of claim 1, wherein the aluminum oxynitride has an oxygen to nitrogen ratio characterized by O/(O+N) of from about 0.5 to 0.95.

12. The coated article of claim 1, wherein the aluminum oxynitride has an oxygen to nitrogen ratio characterized by O/(O+N) of from about 0.56 to 0.93.

13. The coated article of claim 1, wherein the coated article has a photopic reflection of no greater than about 3.0%.

14. The coated article of claim 1, wherein the coated article has a photopic reflection of no greater than about 0.5%.

15. The coated article of claim 1, wherein the medium index layer consists essentially of aluminum oxynitride.

16. The coated article of claim 1, wherein the coated article has a visible transmission of at least about 60%, and the substrate is a glass substrate.

17. The coated article of claim 1, wherein the coating supported by the glass substrate has no electrically conductive layer.

18. The coated article of claim 1, wherein the coating supported by the glass substrate has no layer of Ag or Au.

19. The coated article of claim 1, wherein the coating supported by the glass substrate has no pyrolytic layer.

20. A coated article including an anti-reflection coating supported by a substrate, the coated article comprising:
the substrate supporting the anti-reflection coating, wherein the anti-reflection coating comprises a low index layer having a low index of refraction (n), a medium index layer having a medium index of refraction, and a high index layer having a high index of refraction;
wherein the medium index layer comprises aluminum oxynitride and is located below each of the high index layer and the low index layer in the coating;
wherein the medium index layer comprising aluminum oxynitride has an index of refraction less than that of the high index layer and greater than that of the low index layer.

21. The coated article of claim 20, wherein each of the high, low and medium index layers are dielectric layers.

22. The coated article of claim 20, wherein the medium index layer comprising aluminum oxynitride has an index of refraction from about 1.63 to 2.05.
